(19) United States
(12) Patent Application Publication
(10) Pub. No.: US 2002/0180694 A1
(43) Pub. Date: Dec. 5, 2002

(54) Cover and stand for portable display device

(76) Inventor: Dennis R. Isaacson, Springville, UT (US)

Correspondence Address: Bruce J. Wolstoncroft, Esquire, Barley, Snyder, Senft & Cohen, LLC, 126 East King Street, Lancaster, PA, 17602, US

(21) Appl. No.: 09/874,471

(22) Filed: Jun. 5, 2001

(51) Int. Cl. G09G 5/00

(52) U.S. Cl. 345/156

(57) ABSTRACT

The invention is directed to a cover for use with a portable display device. The cover has a lid which is rotatable between a closed position, through intermediate open positions, to a completely open position. A movable hinge is attached to the lid, such that the lid can rotate about the movable hinge. A fixed hinge is secured to a main body of the portable display device. The movable hinge is mounted to the fixed hinge to allow the movable hinge to be moved in an arcuate motion about the fixed hinge. Positive stop members are provided on the movable hinge and fixed hinge, whereby as the lid is rotated, the positive stop members define the intermediate open positions which position the lid at an angle relative to the main body, thereby allowing the lid to act as a stand for the portable display device. A connecting arm extends between and is pivotally mounted to the movable hinge and the fixed hinge. The stop members are in the form of projections and recesses, whereby as the lid is rotated, the intermediate open positions are defined by the projections being received and maintained in the recesses by resilient spring forces.

### FIELD OF THE INVENTION

The invention relates to a cover for a portable display device which protects the display when in a closed position and acts as a stand when in an open position.

### BACKGROUND OF THE INVENTION

Portable display devices, including pen-based computers have become well known in the industry. The user interface or display of these devices is often fragile. As the displays are often made of glass or plastic, the displays are susceptible to scratching or breakage if the device is dropped or mishandled.

To prevent damage to the display, several portable devices currently on the market have with a separate carrying case that has padding or other protective material. However, when the portable device is being used, the separate case is inconvenient to store and easily misplaced.

In an attempt to provide for a more compact and self contained portable device, covers have become pivotally attached to the device, as represented by U.S. Pat. No. 5,555,157. In this device, the cover is coupled to the housing by a compound hinge that can be moved between a closed position which substantially overlays the display and an open position which substantially overlays a portion of the bottom surface of the housing.

While the covers described above provide protection for the displays of the portable devices when the portable devices are not in use or being transported, they provide no advantage when the devices are in use. In many instances, the portable device is held in the hand or laid flat on a work surface when used. If the user wishes to view the device at an inclined angle, a separate stand must be provided to support the device in position. This arrangement is inconvenient and cumbersome to the user.

U.S. Pat. No. 5,682,182 discloses a cover that can be used without being removed from the main body and can be used as part of the stand. In this device, the cover is moved from a closed position to an open position. In the open position, a support plate provided on a back surface of the housing is rotated and engages slots in the cover, such that the plate and cover cooperate to act as a stand and maintain the device in an angular upright position.

While this device provides both a cover and a stand, the number of pieces and complexity of the mechanism adds to the weight and cost to manufacture. The use of the support plate also occupies a significant portion of the back surface of the support device and adds to the relative thickness, and complexity in assembly, of the device. In addition, the stand is limited in the number of positions that it can support. As the plate must cooperate with the slots, the number of angular positions supported is limited.

It would, therefore, be advantageous to have a cover/stand member which acts as a single member and which can open in a variety of positions. By providing such a member, the back surface can be used for other purposes, such as connecting to a stationary computer or the like.

### SUMMARY OF THE INVENTION

It is an object of the present invention to provide a cover which provides great flexibility to the user. According to the invention, when the cover is in the closed position and completely open position, the cover does not add significantly to the space required for operation. As the cover remains attached to the device at all times, the risk of losing the cover is significantly reduced. Also, as the cover is self contained, no support members or the like are required, thereby reducing the manufacturing cost of the device and reducing the overall weight of the device.

It is also an object of the invention to provide a cover which allows the device to be accessed and viewed from different angles. In many instances users benefit from the use of a stand or cradle to maintain the device in an angular upright position. The invention allows the cover to act independently as a stand, thereby eliminating the need for additional components. The configuration of the cover of the present invention provides for a variety of predetermined positive angular upright positions to be established, thereby further facilitating the user.

In order to achieve the aforementioned objects, the present invention is directed to a cover for use with a portable display device. The cover has a lid which is dimensioned to cover a display of the portable display device. The lid is rotatable between a closed position, through intermediate open positions, to a completely open position. A movable hinge is attached to the lid, such that the lid can rotate about the movable hinge. A fixed hinge is secured to a main body of the portable display device. The movable hinge is mounted to the fixed hinge to allow the movable hinge to be moved in an arcuate motion about the fixed hinge. Positive stop members are provided on the movable hinge and fixed hinge, whereby as the lid is rotated, the positive stop members define the intermediate open positions which position the lid at an angle relative to the main body, thereby allowing the lid to act as a stand for the portable display device.

A connecting arm extends between and is pivotally mounted to the movable hinge and the fixed hinge. First respective positive stop members are provided on the connecting arm, the first respective positive stop members are in the form of first projections and first recesses provided on a hinge engaging surface of the connecting arm. Second respective positive stop members are provided on the movable hinge and the fixed hinge, the second respective positive stop members are in the form of second projections and second recesses provided on connecting arm engaging surfaces. A first pin extends between the connecting arm and the movable hinge and a second pin extends between the connecting arm and the fixed hinge, the first and second pins have spring members which cooperate therewith to provide a resilient spring force, whereby as the lid is rotated, the intermediate open positions are defined by the first projections being received and maintained in the second recesses by the resilient spring force and the second projections being received and maintained in the first recesses by the resilient spring forces.

The hinge engaging surface and the connecting arm engaging surfaces also have shoulders provided thereon. The shoulders cooperate with respective first and second projections as the lid is rotated between certain positions, whereby the shoulders prevent the first projections from being received in the second recesses and the second projections from being received in the first recesses, thereby facilitating the rotation of the lid between certain positions.

The fixed hinge is either integrally attached to the main body portion of the portable display device or removably mounted thereto.

The use of the hinges and spring members provides for a reliable system which is effective over many cycles. As the user must only rotate the cover to overcome the spring forces and as the projections and recesses of the hinges are configured to smoothly transition from one position to the next, the cover will maintain its reliability over time.

The use of the cover of the present invention also minimizes the space required on the main body to accommodate the cover. As the cover is only attached to the main body at the ends of the bottom surface of the main body, the remaining volume of the main body may be used for other purposes. In particular, various portable devices required connectors for data links or power input to be provided on the bottom surface or on the rear face of the main body. The present invention does not interfere with the positioning of these connectors.

The invention also allows the cover to be used in existing designs with little modifications. As the cover can be attached as shown in the alternate embodiment, the use of the cover of the present invention can be used in many applications.

### BRIEF DESCRIPTION OF THE DRAWINGS

FIG. 1 is a perspective view of a portable display device with a cover in a closed position.

FIG. 2 is a perspective view similar to FIG. 1 showing the cover in a partially open position, in which the cover serves as a stand for the portable display device.

FIG. 3 is a perspective view similar to FIG. 1 showing the cover in a completely open position.

FIG. 4 is a side view of the portable display device showing the cover in the closed position.

FIG. 5 is a side view similar to FIG. 5 showing the cover in a partially open position.

FIG. 6 is a side view similar to FIG. 5 showing the cover in a partially open position in which a movable hinge member is moved relative to a fixed hinge member.

FIG. 7 is a side view similar to FIG. 5 showing the cover in a partially open position in which the cover serves as a stand for the portable display device.

FIG. 8 is a side view similar to FIG. 5 showing the cover in a completely open position.

FIG. 9 is partial enlarged view of a connecting arm of the cover showing spring members attached to pins.

FIG. 10 is a partial enlarged view of a hinge member.

FIG. 11 is a top view of a respective connecting arm.

FIG. 12 is a cross-sectional view of a respective movable hinge member.

FIG. 13 is a cross-sectional view of a respective fixed hinge member.

FIG. 14 is a cross-sectional view of a respective connecting arm.

FIG. 15 is a cross-sectional view showing the spring member housed in a cavity.

FIG. 16 is a perspective view of an alternate embodiment of the invention showing a cover that can be removably attached to a portable display device.

FIG. 17 is an exploded perspective view of the embodiment shown in FIG. 16.

### DETAILED DESCRIPTION OF THE INVENTION

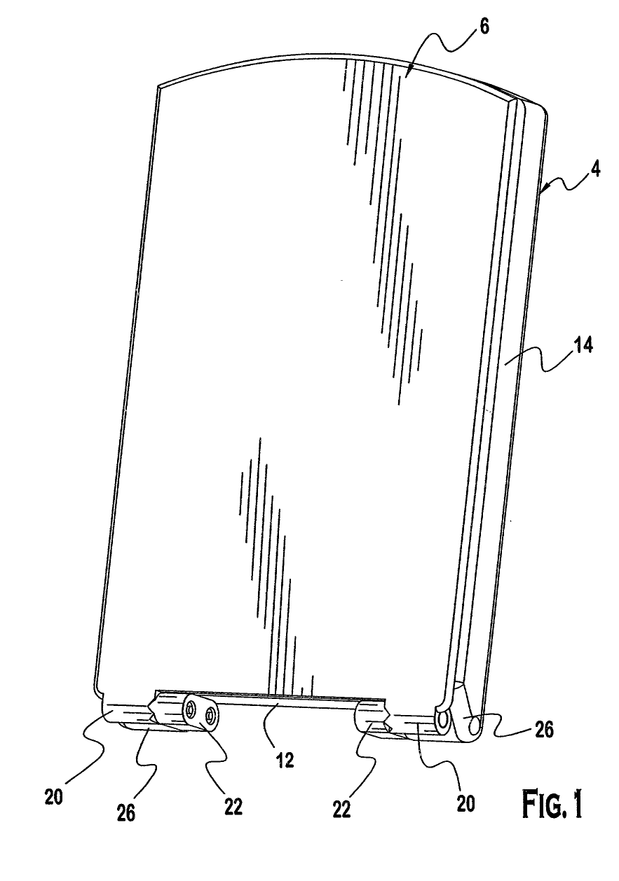

FIG. 1 illustrates a personnel digital assistant (PDA) to which the cover of the present invention is attached. In the embodiment shown the device is a PDA but other portable display devices can be used without departing from the scope of the invention. FIG. 1a shows the front face 2 of the main body 4 covered by a cover 6. FIG. 1b shows the cover 6 pivoted and proximate to the rear face 8 of the main body 4. This is defined as the completely open position. FIG. 1c illustrates the cover 6 in an intermediate open position in which the cover 6 has been pivoted toward the rear face 8. In this position, the cover 6 acts as a stand, as will be more fully discussed.

The main body 4 has a top surface 10, bottom surface 12 and side surfaces 14 that extend between the front face 2 and rear face 8. The terms front, rear, top, bottom and sides refer to the embodiment shown. Other orientations of the device are contemplated without departing from the scope of the invention. A display or user interface 16 is positioned on the front face 2 of the main body 4. As portable display devices are known in the industry, a more detailed explanation of the features provided on the main body will not be provided.

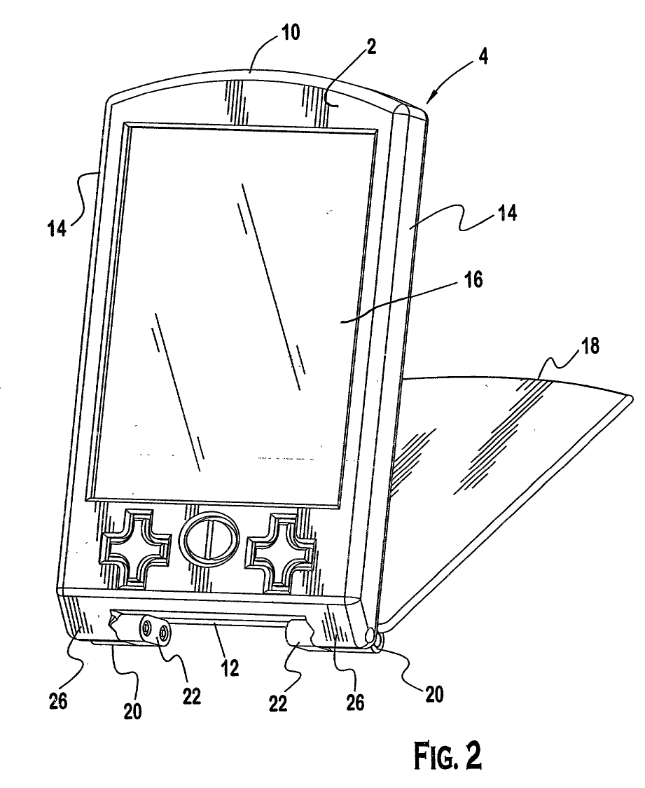

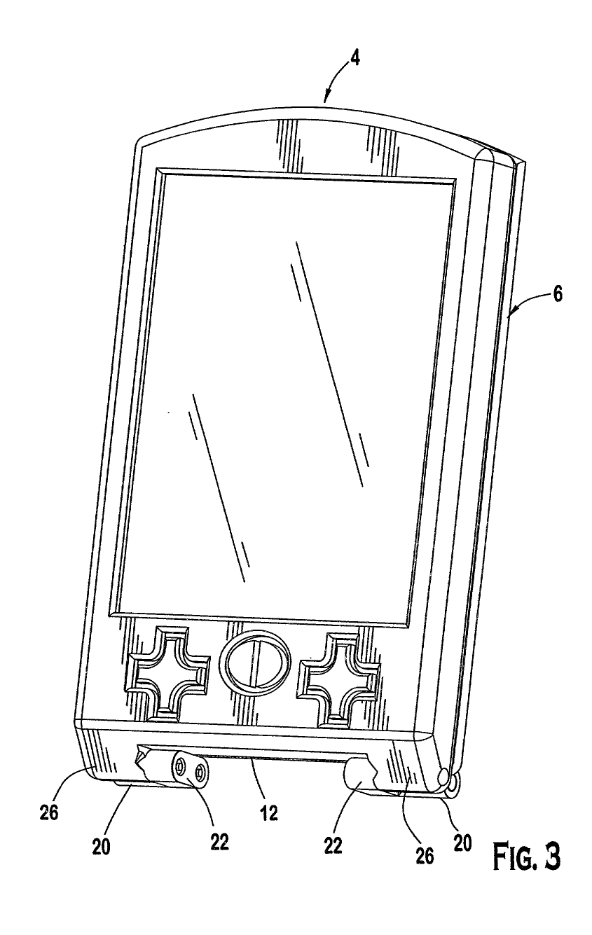

As shown in FIGS. 1 and 2, the cover 6 has a rectangular lid 18 having a size slightly smaller than the main body 4. The lid has a pair of movable hinge members 20 attached to the lower edge thereof. As best shown in FIG. 1 through 3, the movable hinge members 20 are positioned proximate the bottom surface 12 and proximate the side surfaces 14 of the main body 4. A connecting arm 22 extends from an inner end 24 of each movable hinge member 20. The connecting arms 22 extend to and are connected to fixed hinged members 26 that are fixedly mounted on the main body 4 at the bottom surface 12. The fixed hinged members 26 are positioned in line with the movable hinge members 20. The connecting arms 22 are mounted to both the movable hinge members 20 and the fixed hinge members 26 is such a manner to allow the connecting arms 22 to have rotational movement about the members 20 and 26.

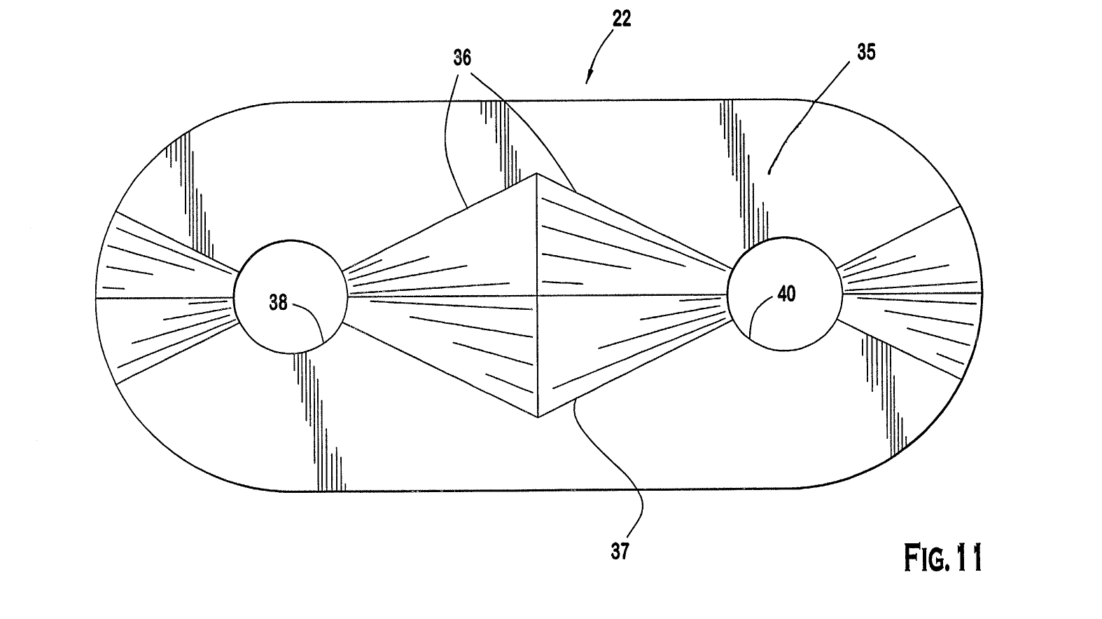

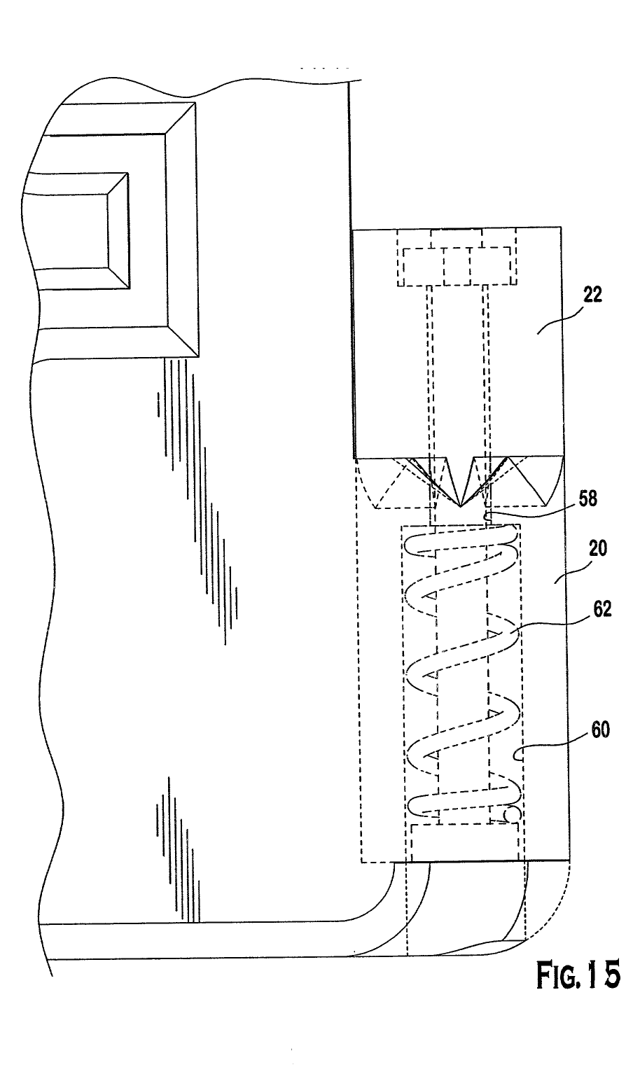

Referring to FIGS. 9, 11 and 14, each connecting arm 22 has an outer surface 30 and an inner surface 32. The inner surfaces 32 have projections 34 that extend therefrom in a direction away from the outer surfaces 30. Recesses 35 and shoulders 37 are also provided on the inner surfaces. The projections 34 have sloping walls 36. The particular configuration of the projections, recesses and shoulders may be varied according to the type of movement desired, as will be more fully discussed. A pair of openings 38, 40 are provided on each connecting arm 22, the openings 38, 40 extend from the outer surface 30 through the inner surface 32. The openings 38, 40 are dimensioned to receive pins 42, 44 therein.

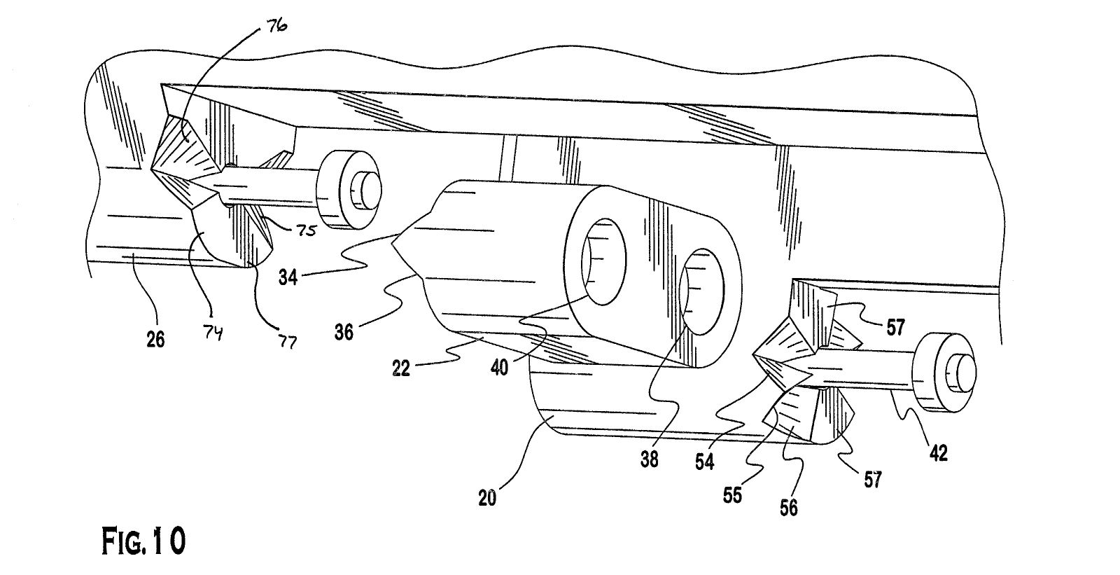

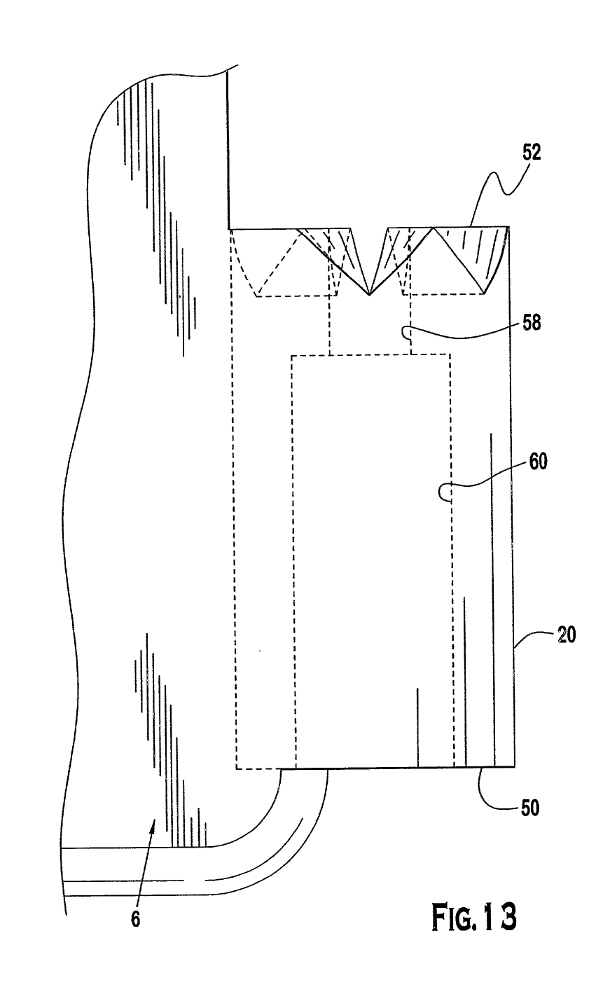

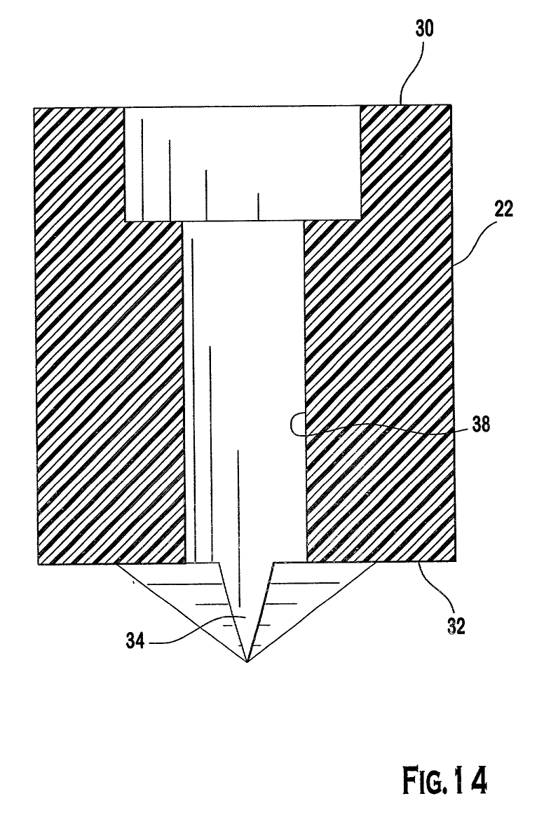

As shown in FIGS. 10 and 13, each movable hinge member 20 has an outer surface 50 and an inner surface 52. The inner surfaces 52 have projections 54 that which extend therefrom in a direction away from the outer surface 50. Recesses 55 and shoulders 57 are also provided on the inner surfaces. The projections 54 have sloping walls 56. The particular configuration of the projections, recesses and shoulders may be varied according to the type of movement desired, as will be more fully discussed. An opening 58 is provided in each movable hinge member 20, the openings 58 extend from the outer surfaces 50 through the inner surfaces 52. Each opening 58 is dimensioned to receive a respective pin 42 therein. Cavities 60 are provided around the circumference of portions of the openings 58. The cavities 60 are dimensioned to receive sprig members 62 therein.

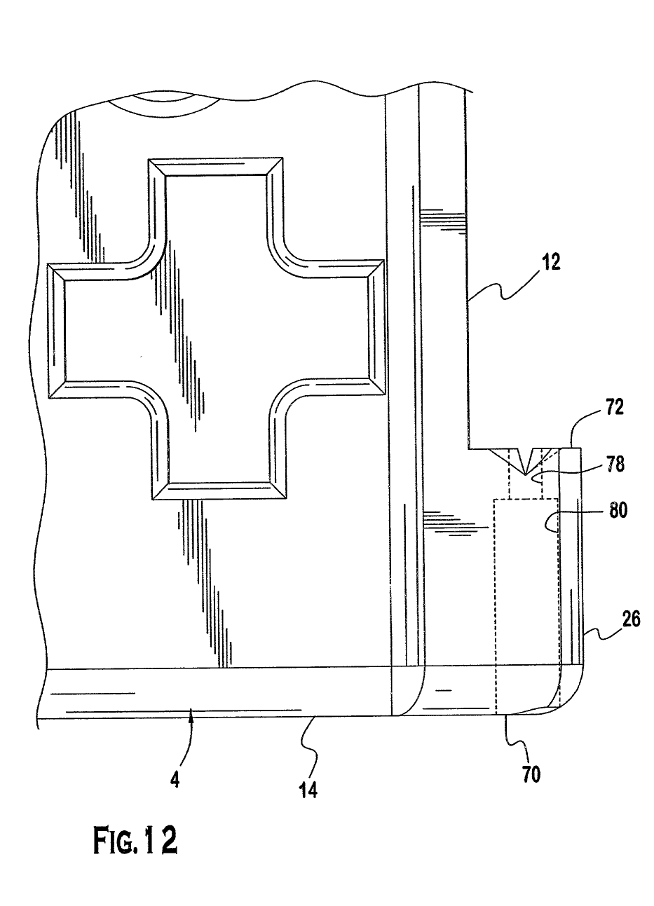

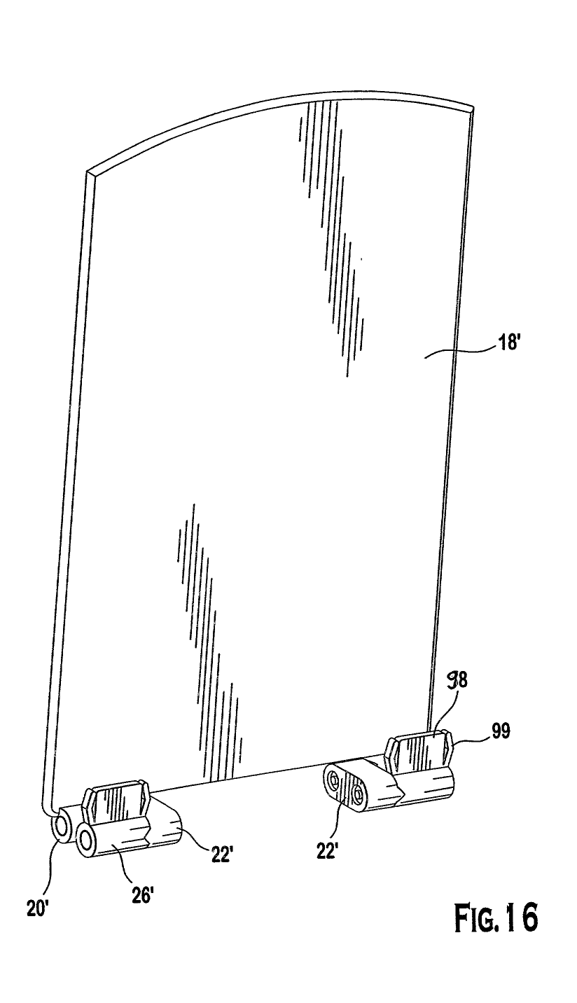

As shown in FIGS. 12 and 15, each fixed hinge member 26 has an outer surface 70 and an inner surface 72. The inner surfaces 72 have projections 74 that which extend therefrom in a direction away from the outer surface 70. Recesses 75 and shoulders 77 are also provided on the inner surfaces. The projections 74 have sloping walls 76. The particular configuration of the projections, recesses and shoulders may be varied according to the type of movement desired, as will be more fully discussed. An opening 78 is provided in each movable hinge member 26, the openings 78 extend from the outer surfaces 70 through the inner surfaces 72. Each opening 78 is dimensioned to receive a respective pin 44 therein. Cavities 80 are provided around the circumference of portions of the openings 78. The cavities 80 are dimensioned to receive sprig members 82 therein.

Pins 42 have enlarged first ends 90 and enlarged second ends 92. Similarly, pins 44 have enlarged first ends 94 and enlarged second ends 96. These enlarged ends cooperate with the hinge members and connecting arms to maintain the assembly in an assembled state. The enlarged ends also cooperate with the springs to provide the resilient force required.

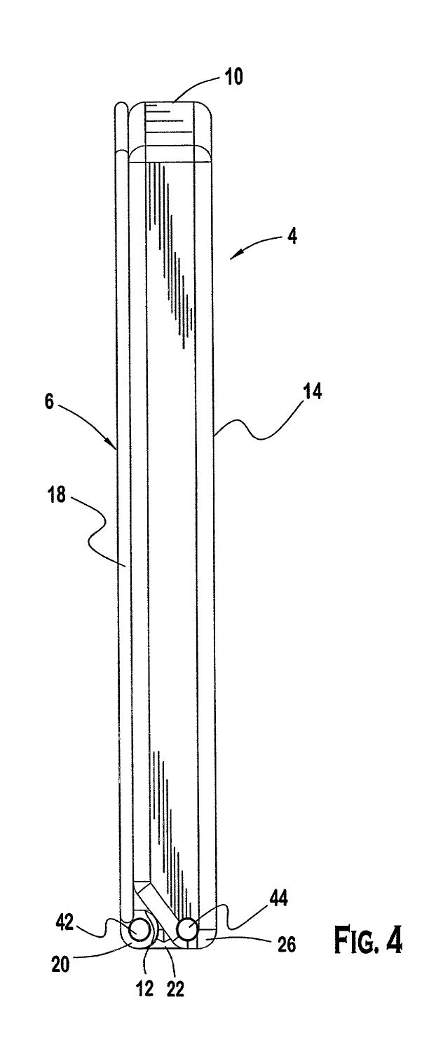

Referring to FIGS. 4 through 8, the operation of the cover 6 will be described. It is important to note that the cover 6 is attached to the main body 4 by means of pins 42, 44. As each pins has enlarged ends, the pins are fixed in position by using any of the conventional means known in the art for securing such pins.

FIGS. 1 and 4 illustrate the cover 6 in a closed position, i.e. the cover 6 is proximate to and engages the front face 2 of the main body 4. The cover 6 is maintained in this position by the cooperation of projections 34 of connecting arms 22 with recesses 55 of movable hinge member 20 and recesses 75 of fixed hinge member 26. The projections 34 are positioned in recesses 55 and 75 and are maintained therein by the resilient forces provided by springs 62 and 82. As the springs are slightly stretched when the projections 34 are in recesses 55 and 75, the movement of the projections out of and away from the recesses will further stretch the spring. Therefore, the movement of the projections out of the recesses is resisted by the spring forces of the springs.

In order to move the cover from the front face a force is applied to the cover. Upon application of a sufficient force, the sloping walls 36 of projections 34 will engage and slide over the sloping walls 56 of projections 54 of moveable hinge member 20. The application of the force causes the spring force to be overcome, allowing the movement of the connecting arms 22 relative to the movable hinge members 20. Due to the respective configurations of the projections, recesses and shoulders of hinges 20 and 26 and arms 22 only the lid 18 pivots about movable hinge member 20 during this initial movement. The movable hinge member 20 is not rotated relative to the fixed hinge member 26.

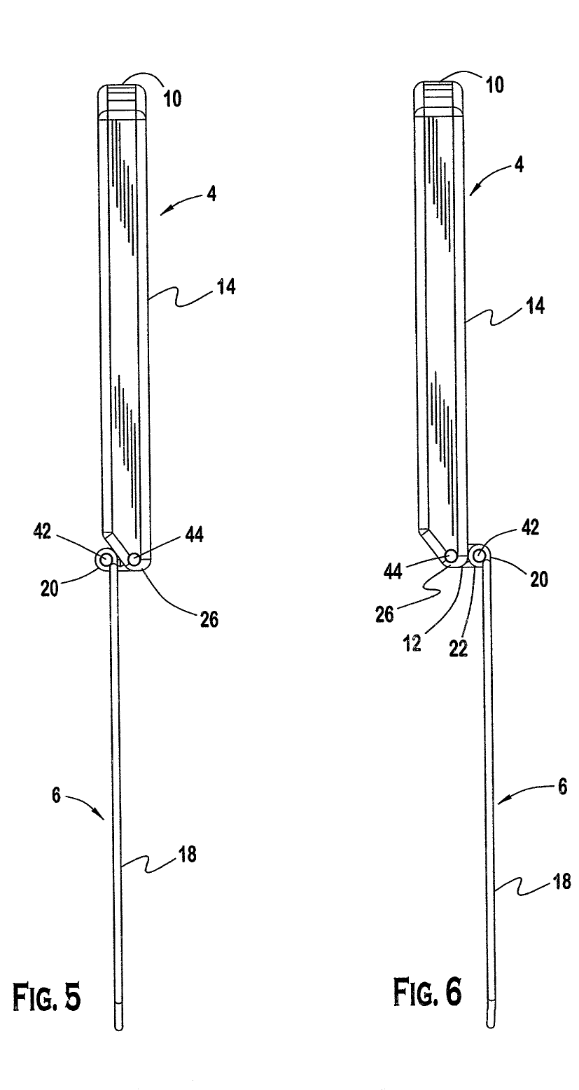

As the lid 18 is moved from the position shown in FIG. 4 to the position shown in FIG. 5, the projections 34 of the connecting arms 22 engage shoulders 57 of the movable hinge members 20. The engagement of the projections 34 with the shoulders 57 maintains a constant spacing of the movable hinge members 20 with respect to the connecting arms 22, and therefore, a consistent spring force is supplied by the springs 62. As varied forces need not be applied to the cover to overcome varied spring forces, the movement of the lid 18 between the positions shown is easily accomplished.

As movement of the lid 18 continues to the position shown in FIG. 6, the movable hinge member 20 is moved relative to the fixed hinge member 26. As this occurs the sloping walls 36 of projections 34 of connecting arms 22 engage and slide over the sloping walls 76 of projections 74 of the fixed hinge member 26. As the movable hinge members 20 are rotated from the position shown in FIG. 5 to the position shown in FIG. 6, the projections 34 of the connecting arms 22 engage shoulders 77 of the fixed hinge members 26. The engagement of the projections 34 with the shoulders 77 maintains a constant spacing of the fixed hinge members 26 with respect to the connecting arms 22, and therefore, a consistent spring force is supplied by the springs 82. As varied forces need not be applied to the cover to overcome varied spring forces, the movement of the lid 18 between the positions shown is easily accomplished.

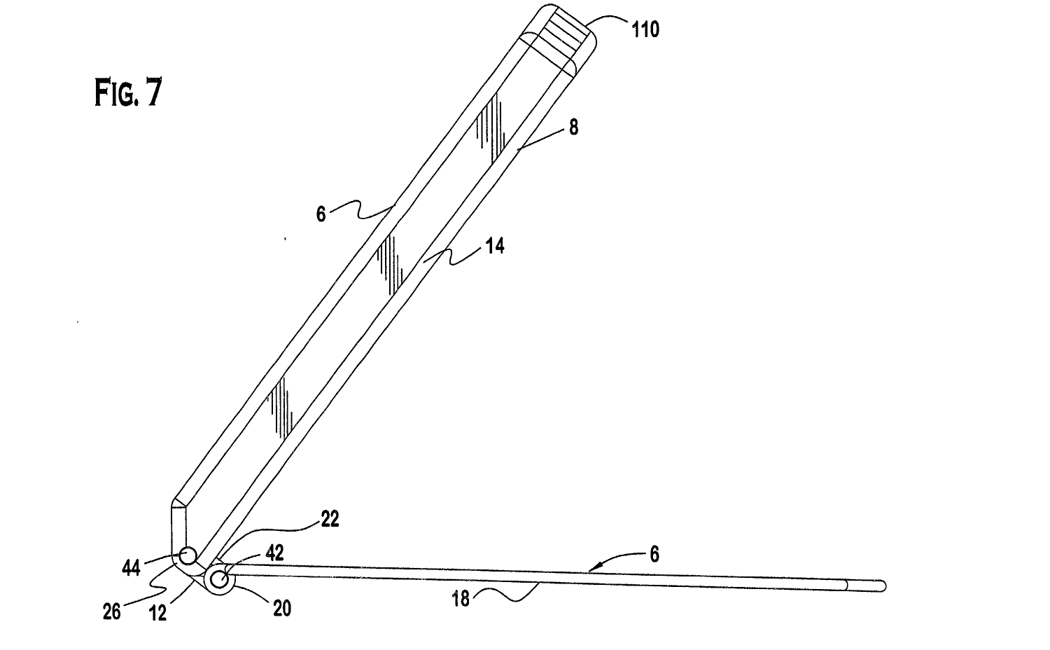

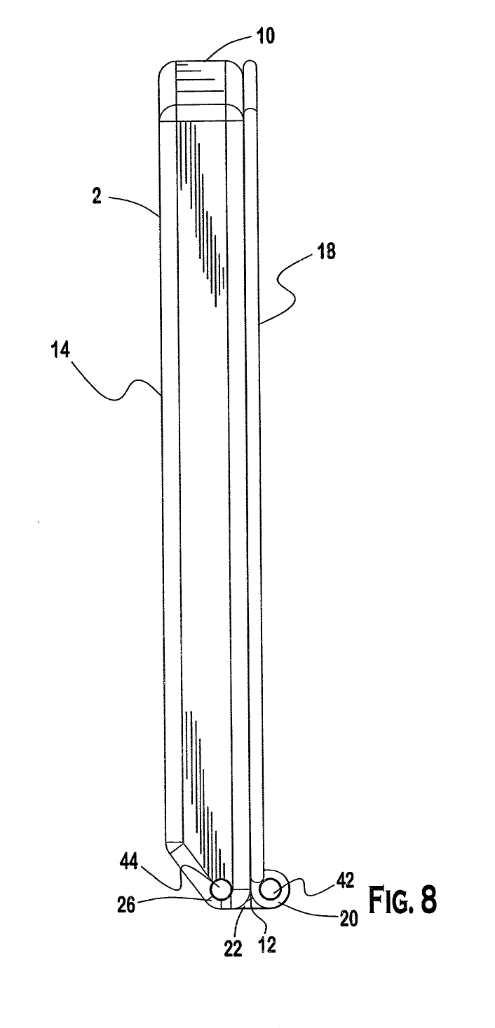

The movement of the lid 18 continues until the position shown in FIG. 7 is reached. When the lid 18 reaches this position, the projections 34 are received in recesses 55 and 75 and projections 54 and 74 are received in recesses 35. As this occurs the springs 62 and 82 attempt to resiliently return to their unstressed positions. This causes the projections and recesses to be pulled together, thereby providing a positive stop to hold the cover in the position shown in FIG. 7. In this position, the lid 18 provides a solid and stable base that maintains the main body 4 in an angular upright position. The particular angle of inclination of the main body is dependent upon the positioning of the projections and recesses. As the position shown in FIG. 7 occurs when the recesses and projections are aligned as described, the rotational positioning of the projections and recesses on the hinge and arm govern the angle of inclination of the main body. Therefore, by altering the positioning of the recesses and projections the angle of inclination is altered. Also, by varying the dimensioning and number of projections and recesses, numerous angular upright positions can be established, thereby providing maximum flexibility to the user.

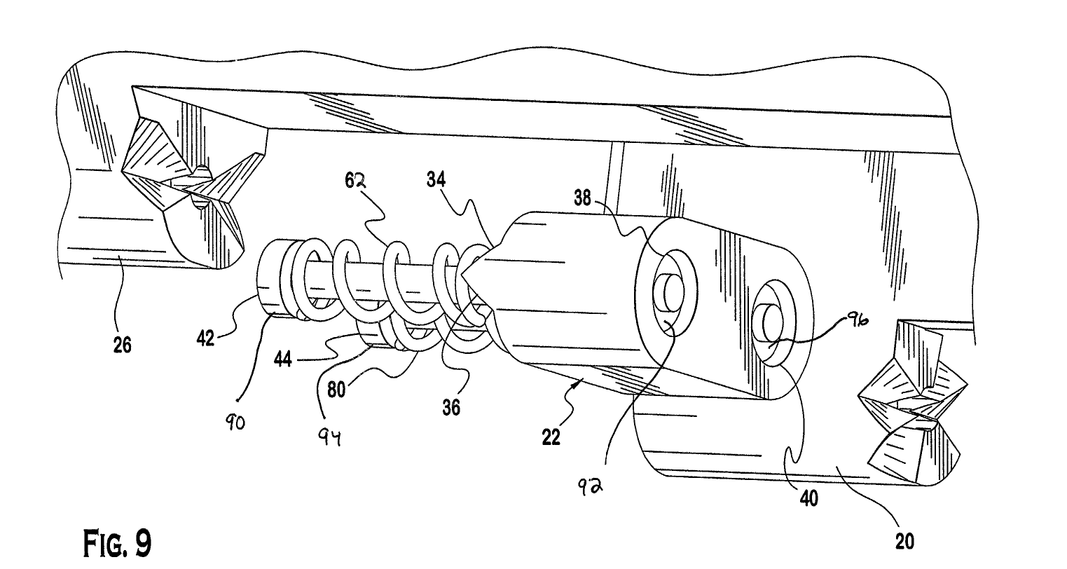

If a stand or base is not required during operation, the lid 18 is moved to the position shown in FIG. 8. To accomplish this a sufficient force is applied to the lid 18 to overcome the spring force and positive stop described above to rotate the lid to the completely open position. In this completely open position lid 18 is essentially parallel and in engagement with the rear face 8 of the main body 4. During this movement, the movable hinge member 20 does not move relative to the fixed hinge member 26. The only movement is the rotation of the lid 18 about the movable hinge member 20 similar to that previously described. When the lid 18 is in the position shown in FIG. 8 the recesses and projections are aligned so that a positive stop is provided as previously described.

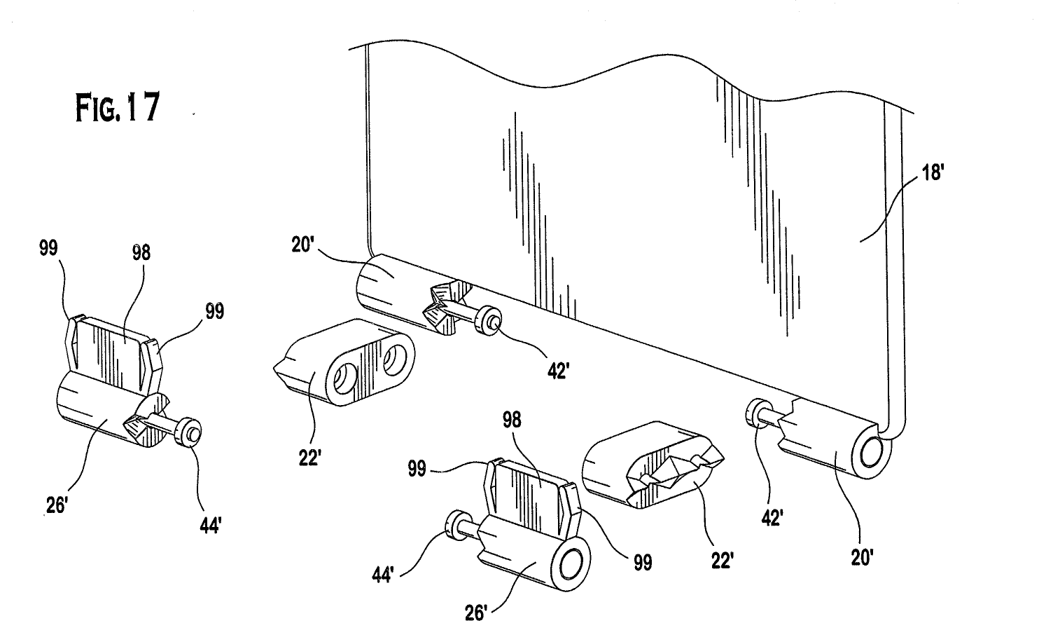

FIGS. 16 and 17 illustrate an alternate embodiment of the invention. For ease of explanation and understanding, the same reference numbers designated by a prime mark will be used when appropriate. In this embodiment each fixed hinged member is not integrally attached to the main body. Rather each fixed hinged member is removably attached through the use of a projection 98 with resilient arms 99 extending from side thereof. The projections 98 and arms 99 are inserted into slots (not shown) provided in the main body 4′ and secured therein through frictional engagement. However, once attached, the operation of the cover is the same, and therefore, the detailed explanation of the operation will not be repeated.

The invention described herein is provides great flexibility to the user. In the closed position and completely open position, the cover does not add significantly to the space required for operation. As the cover remains attached to the device at all times, the risk of losing the cover is significantly reduced. Also, as the cover is self contained, no support members or the like are required, thereby reducing the manufacturing cost of the device and reducing the overall weight of the device.

The multi-positional aspect of the stand can also be advantageous. In many instances users benefit from the use of a stand to maintain the device in an angular upright position. This facilitates access and viewing of the display of the device. The invention allows the cover to act as a stand, thereby eliminating the need for additional components. The configuration of the hinges of the cover of the present invention provides for a variety of positive positions to be established thereby further facilitating the user.

The use of the hinges and spring members provides for a reliable system which is effective over many cycles. As the user must only rotate the cover to overcome the spring forces and as the projections and recesses of the hinges are configured to smoothly transition from one position to the next, the cover will maintain its reliability over time.

The use of the cover of the present invention also minimizes the space required on the main body to accommodate the cover. As the cover is only attached to the main body at the ends of the bottom surface of the main body, the remaining real estate of the main body may be used for other purposes. In particular, various portable device required connectors for data links or power input to be provided on the bottom surface or on the rear face of the main body. The present invention does not interfere with the positioning of these connectors.

The invention also allows the cover to be used in existing designs with little modifications. As the cover can be attached as shown in the alternate embodiment, the use of the cover of the present invention can be used in many applications.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A cover for use with a portable display device, the cover comprising:
a lid dimensioned to cover a display of the portable display device, the lid is rotatable between a closed position, through intermediate open positions, to a completely open position;
a movable hinge attached to the lid, such that the lid can rotate about the movable hinge;
a fixed hinge secured to a main body of the portable display device, the movable hinge being mounted to the fixed hinge to allow the movable hinge to be moved in an arcuate motion about the fixed hinge;
positive stop members provided on the movable hinge and fixed hinge;
whereby as the lid is rotated the positive stop members define intermediate open positions which position the lid at an angle relative to the main body, thereby allowing the lid to act as a stand for the portable display device.

2. The cover as recited in claim 2 wherein a connecting arm extends between and is pivotally mounted to the movable hinge and the fixed hinge.

3. The cover as recited in claim 2 wherein first respective positive stop members are provided on the connecting arm, the first respective positive stop members are in the form of first projections and first recesses provided on a hinge engaging surface of the connecting arm.

4. The cover as recited in claim 3 wherein second respective positive stop members are provided on the movable hinge and the fixed hinge, the second respective positive stop members are in the form of second projections and second recesses provided on connecting arm engaging surfaces.

5. The cover as recited in claim 4 wherein a first pin extends between the connecting arm and the movable hinge and a second pin extends between the connecting arm and the fixed hinge, the first and second pins have spring members which cooperate therewith to provide a resilient spring force, whereby as the lid is rotated, the intermediate open positions are defined by the first projections being received and maintained in the second recesses by the resilient spring force and the second projections being received and maintained in the first recesses by the resilient spring forces.

6. The cover as recited in claim 5 wherein the hinge engaging surface and the connecting arm engaging surfaces have shoulders provided thereon, the shoulders cooperate with respective first and second projections as the lid is rotated between certain positions, whereby the shoulders prevent the first projections from being received in the second recesses and the second projections from being received in the first recesses, thereby facilitating the rotation of the lid between certain positions.

7. The cover as recited in claim 1 wherein the fixed hinge is integrally attached to the main body portion of the portable display device.

8. The cover as recited in claim 1 wherein the fixed hinge is removably mounted to the main body portion of the portable display device.

9. A cover for use with a portable display device, the cover comprising:
a lid dimensioned to cover a display of the portable display device, the lid is rotatable between a closed position, through intermediate open positions, to a completely open position;
a pair of movable hinges attached to the lid, such that the lid can rotate about the movable hinges;
a pair of fixed hinges secured to a main body of the portable display device;
a pair of connecting arms extending between the movable hinges and the fixed hinges, the movable hinges being mounted to the fixed hinges by the connecting arms, thereby allowing the movable hinges to be moved in an arcuate motion about the fixed hinges;
positive stop members provided on the movable hinges, fixed hinges and connecting arms;
whereby as the lid is rotated, the positive stop members define intermediate open positions which position the lid at an angle relative to the main body, thereby allowing the lid to act as a stand for the portable display device.

10. The cover as recited in claim 9 wherein first respective positive stop members are provided on the connecting arms, the first respective positive stop members are in the form of first projections and first recesses provided on hinge engaging surfaces of the connecting arms.

11. The cover as recited in claim 10 wherein second respective positive stop members are provided on the movable hinges and the fixed hinges, the second respective positive stop members are in the form of second projections and second recesses provided on connecting arm engaging surfaces.

12. The cover as recited in claim 11 wherein first pins extend between the connecting arms and the movable hinge and second pins extend between the connecting arms and the fixed hinges, the first and second pins have spring members which cooperate therewith to provide a resilient spring force, whereby as the lid is rotated, the intermediate open positions are defined by the first projections being received and maintained in the second recesses by the resilient spring force and the second projections being received and maintained in the first recesses by the resilient spring forces.

13. The cover as recited in claim 12 wherein the hinge engaging surfaces and the connecting arm engaging surfaces have shoulders provided thereon, the shoulders cooperate with respective first and second projections as the lid is rotated between certain positions, whereby the shoulders prevent the first projections from being received in the second recesses and the second projections from being received in the first recesses, thereby facilitating the rotation of the lid between certain positions.

14. The cover as recited in claim 9 wherein the fixed hinges are integrally attached to the main body portion of the portable display device.

15. The cover as recited in claim 9 wherein the fixed hinges are removably mounted to the main body portion of the portable display device.

16. The cover as recited in claim 9 wherein the movable hinges and fixed hinges are provided proximate a bottom surface of the main body, a first fixed hinge is proximate to the plane of a first side surface of the main body and a second fixed hinge is proximate to the plane of a second side surface of the main body.

17. The cover as recited in claim 12 wherein the spring members are housed in cavities provided in the movable hinges and the fixed hinges.
